(19) United States
(12) Patent Application Publication
(10) Pub. No.: US 2013/0119632 A1
(43) Pub. Date: May 16, 2013

(54) STEERING LIMIT DEVICE OF SHOCK ABSORBENT FORK

(71) Applicant: HSIN LUNG ACCESSORIES CO., LTD, Hsin-Chu (TW)

(72) Inventor: Hsueh-Sen LIAO, Hsin-Chu (TW)

(73) Assignee: HSIN LUNG ACCESSORIES CO., LTD, Hsin-Chu (TW)

(21) Appl. No.: 13/652,553

(22) Filed: Oct. 16, 2012

(30) Foreign Application Priority Data
Nov. 14, 2011 (TW) 100221491

(51) Int. Cl. B62K 21/20

(52) U.S. Cl. 280/276

(57) ABSTRACT

A steering limit device includes an external tube and a shaft tube coupled to a handlebar and a fork of a bicycle respectively. The external tube has a plurality of first rotation limit portions disposed on an inner wall of a predetermined section of the external tube; the shaft tube has a plurality of second rotation limit portions corresponding to the first rotation limit portions respectively formed on an outer wall of the section of the shaft tube being extended into the external tube and a plurality of first pads installed between the first rotation limit portions and the second rotation limit portions, and each first pad limits the relative rotation of the external tube and the shaft tube to achieve the effect of controlling the fork steering effect by the handlebar of the bicycle.

### FIELD OF THE INVENTION

The present invention relates to a steering limit device, in particular to a shock absorbent fork used in a bicycle to maintain the original steering control function of the bicycle or even capable of providing a steering limit device with a shock absorption effect.

### BACKGROUND OF THE INVENTION

In general, handlebars are used for controlling the extend of turning a front wheel to the left or right to maintain the balance of making a turn for the bicycle, and most handlebars of the bicycle can be used to make a turn slowly by means of the distance between a forwardly extended vertical tube for extending the handlebar and an upper tube of the fork. In addition, a pressing module is provided for combining the upper tube of the fork, so that a desired stability between the upper tube of the fork and a bicycle frame can be maintained.

As the functions and applications of the bicycle are enhanced continuously, the conventional steering mechanism no longer can satisfy the design requirements of the bicycle. For example, riders have to lift their buttock from a bicycle seat in an actual ride on a bump road or during acceleration, but the center of gravity of the riders tends to tilt forwardly towards the handlebar, and the handlebar supports the force applied by the riders to maintain balance. Similarly, the vibration at the front wheel is transmitted to both arms of the riders through the steering mechanism.

Therefore, most steering mechanisms between the bicycle handlebars and the fork come with a stable joint structure as well as an appropriate shock absorption effect, in hope of improving the comfort or the riders, reducing exercise injuries. The conventional bicycle steering mechanism with the shock absorption effect of this sort generally includes an external tube used as a first connecting member for connecting the handlebar, a core shaft extended into the external tube and used as a second connecting member for connecting the fork, and a spring installed between the external tube and the core shaft for providing an elastically restoring function of the external tube and the core shaft, so as to provide a buffer or shock absorbing function of the bicycle.

In addition, most bicycle bodies available in the market are formed by a plurality of tubes, and an external wall at the section for installing and connecting the steering mechanism and bicycle body must have a circular cross-section before the section can be turned together with the bicycle body correspondingly, regardless of the section being made of one or more tubes or rods. The relative rotation between the tubes and rods affects the original steering control function of the bicycle, and such arrangement not only causes inconvenient use and operation, but also incurring a risk of unable to control the steering normally, particularly when the conventional steering mechanism of this sort requires the shock absorption effect.

### SUMMARY OF THE INVENTION

In view of the aforementioned problems, it is a primary objective of the present invention to provide a steering limit device applied in a bicycle fork to maintain the original steering control function of the bicycle or the bicycle fork may even be capable of providing a shock absorption effect.

To achieve the foregoing objective, the present invention provides a steering limit device of a shock absorbent fork, comprising an external tube, a shaft tube, and plurality of first pads, wherein he external tube is provided for connecting a handlebar of a bicycle, and the external tube has a plurality of first rotation limit portions disposed on an inner wall of a predetermined section of the external tube; the shaft tube has a plurality of second rotation limit portions corresponding to the first rotation limit portions respectively formed on an outer wall of the section of the shaft tube being extended into the external tube and a plurality of first pads installed between the first rotation limit portions and the second rotation limit portions, and each first pad limits the relative rotation of the external tube and the shaft tube to achieve the effect of controlling the fork steering effect by the handlebar of the bicycle.

Each first pad is installed between the corresponding first rotation limit portion and second rotation limit portion, and each first pad can be disposed axially with respect to the external tube and the shaft tube, and each first pad together with the first rotation limit portion and the second rotation limit portion can limit the relative rotation of the external tube and the shaft tube to achieve the effect of controlling the fork steering effect by controlling the handlebar of the bicycle.

More specifically, the steering limit device of the shock absorbent fork in accordance with the present invention has the following effects:

1. The first pad is provided for reducing the contact gap between the external tube and the shaft tube to achieve a stable and reliable steering limit effect.

2. If necessary, the worn-out first pad is replaced, so that the service life of the steering limit device can be extended effectively.

3. A simpler and more reliable design is provided for providing the shock absorption effect easily.

4. The design of the recession and protrusion of the first pad improves the adhesion of the lubricating oil, so that the external tube and the shaft tube can slide more smoothly to reduce the wearing of related components.

5. The design of using the plurality of first pads to surround the shaft tube can facilitate the assembling, maintenance and repair operations.

### BRIEF DESCRIPTION OF THE DRAWINGS

FIG. 1 is a perspective view of a fork steering limit device of a shock absorbent fork in accordance with the present invention;

FIG. 2 is an exploded view of a fork steering limit device of a shock absorbent fork in accordance with the present invention;

FIG. 3 is a cross-sectional view of a fork steering limit device of a shock absorbent fork in accordance with the present invention; and

FIG. 4 is a top cross-sectional view of a fork steering limit device of a shock absorbent fork in accordance with the present invention.

### DESCRIPTION OF THE PREFERRED EMBODIMENTS

The technical characteristics of the present invention will become apparent with the detailed description of the preferred embodiments accompanied with the illustration of related drawings as follows.

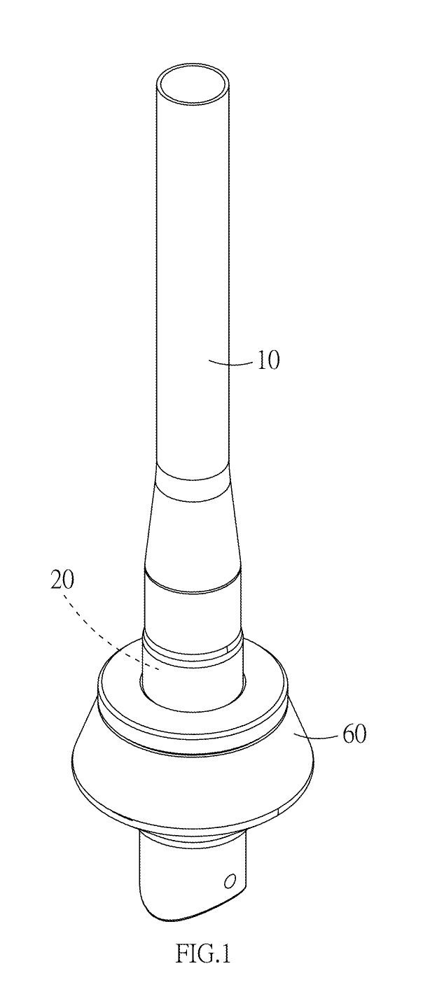

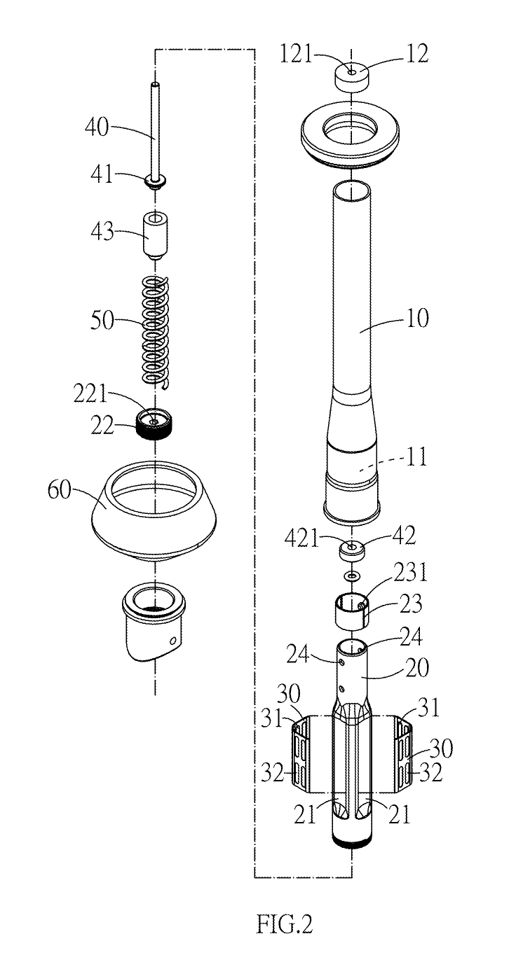

With reference to FIGS. 1 to 3 for a perspective view, an exploded view and a cross-sectional view of a steering limit device of the present invention respectively, the steering limit device is applied in a bicycle fork for maintaining the original steering control function of the bicycle or the fork can even provide a shock absorption effect, wherein the steering limit device comprises an external tube 10, a shaft tube 20, and a plurality of plurality of first pads 30.

The external tube 10 is provided for connecting a handlebar of the bicycle, and the external tube 10 has a plurality of first rotation limit portions 11 disposed on an inner wall of a predetermined section of the external tube 10. In practice, each first rotation limit portion 11 is a cross-section that can be extended axially into the external tube 10.

The shaft tube 20 is passed into the external tube 10 for connecting the fork of the bicycle, and the shaft tube 20 has a plurality of second rotation limit portions 21 disposed on an outer wall of a section extended into the external tube 10 and corresponding to the first rotation limit portions 11 respectively. During practice, each second rotation limit portion 21 is a cross-section that can be extended axially along the shaft tube 20.

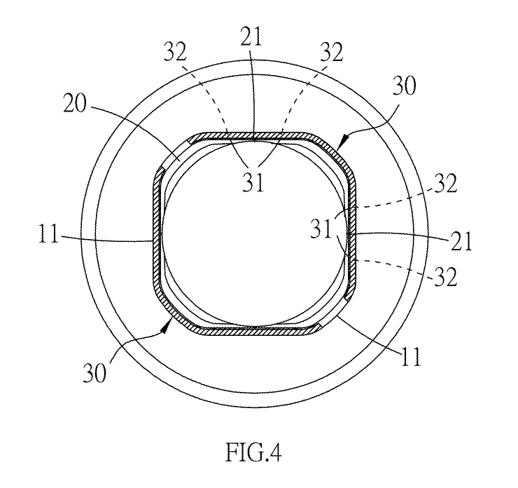

Each first pad 30 is installed between the corresponding first rotation limit portion 11 and second rotation limit portion 21. During practice, each first pad 30 is integrally coupled to a plurality of sections disposed between the corresponding first rotation limit portion 11 and second rotation limit portion 21, and each first pad 30 can be displaced axially with respect to the external tube 10 and the shaft tube 20, and each first pad working together with the first rotation limit portion 11 and the second rotation limit portion 21 (as shown in FIG. 4) limits the relative rotation of the external tube 10 and the shaft tube 20, so as to achieve the effect of controlling the fork steering effect by the handlebar of the bicycle.

Basically, the steering limit device of the present invention can limits the relative rotation of the external tube 10 and the shaft tube 20 by the design of the first rotation limit portion 11 and the second rotation limit portion 21 between the external tube 10 and the shaft tube 20, so as to achieve the effect of controlling the fork steering effect by the handlebar of the bicycle. More particularly, the steering limit device of the present invention adopts the first pad 30 to reduce the gap between the external tube 10 and the shaft tube 20 (which is the gap between the first rotation limit portion 11 and the second rotation limit portion 21) to achieve a more stable and reliable steering limit effect.

In addition, the steering limit device of the present invention further comprises a guide column 40 passed into the shaft tube 20 for limiting the relative sliding stroke of the shaft tube 20 and the external tube 10, and an elastic element 50 installed between the guide column 40 and the shaft tube 20 for providing an elastic restoration effect of the external tube 10 and the shaft tube 20, such that the steering limit device can achieve the shock absorption effect by the simpler and more reliable design.

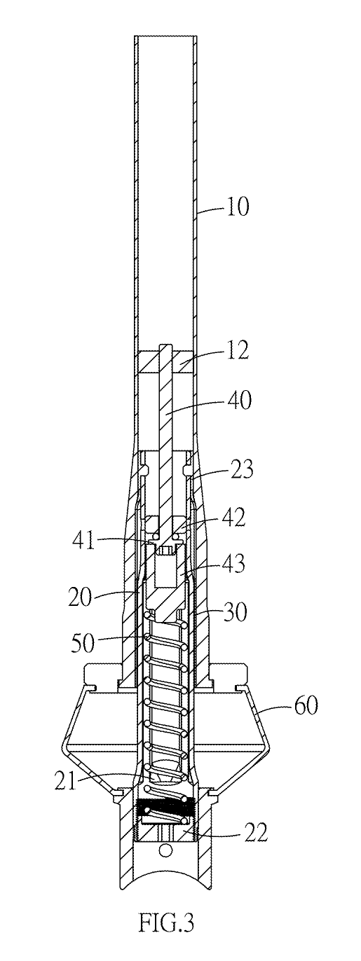

During practice, the external tube 10 has a fixed block 12 disposed on an inner wall at the top of the shaft tube 20, and screw hole 121 formed at the center of the fixed block 12, and the top end of the guide column 40 is passed through the shaft tube 20 and screwed into the screw hole 12 of the fixed block 12, and a disc cover 22 is installed at the bottom end of the shaft tube 20 for restricting the elastic element 50 from falling out, and a through hole 221 is formed at the center of the disc cover 22, and a support ring 42 is installed at a position proximate to a bottom end of the guide column 40, and the guide column 40 is passed through the support ring, and a stop portion 41 is disposed at the bottom of the through hole 421 and has an external diameter greater than the through hole 421 of the support ring 42, and the stop portion 41 is disposed at the top position of he elastic element 50 and abutted with the elastic element 50. Of course, the stop portion 41 can be abutted and coupled with the elastic element 50 through the pushing member 43 as indicated in FIG. 3.

With the aforementioned structural design, a buffer or shock absorption effect is formed when the shaft tube 20 and the external tube 10 are compressed, and an action force is produced to restore the positions of the shaft tube 20 and the external tube 10, and can assure a secured connection between the shaft tube 20 and the external tube 10 to prevent the shaft tube 20 and the external tube 10 from being loosened or fallen out.

It is noteworthy to point out that in the steering limit device of the present invention, the shaft tube 20 has a section of the second rotation limit portion 21 with an external diameter greater than the external diameter of the upper section, regardless of having or not having the shock absorption effect, and the external tube 10 provided for the sliding section of the shaft tube 20 has an external diameter greater than the external diameter of its upper section, so that the external tube has a greater contact area with an actuating part to prevent side rotation and yaws and provide better stability. The external tube 10 can further have an elastic dustproof cover 60 disposed at the bottom of the external tube 10 and coupled to the bicycle fork.

In the steering limit device of a shock absorbent fork in accordance with the present invention, the shaft tube 20 has a plurality of second pads 23 fixed at an upper section of the second rotation limit portion 21 and slidably contacted with an inner wall of the external tube 10. During practice, a positioning column 231 and a positioning hole 24 between each second pad 23 and the shaft tube 20 are provided for fixing with one another by embedment, so that the action of the second pad 23 can provide a stable slide of the shaft tube 20 and the external tube 10, wherein each second rotation limit portion 21 of the shaft tube 20 is in a concave arc shape, and each first pad 30 has a plurality of protrusions 31 disposed at a section corresponding to the second rotation limit portion 21, and each first pad 30 has a plurality of recessions 32 disposed at a section corresponding to the first rotation limit portion 11. With the design of the recessions and protrusions 32, 31 of the first pad 30, the adhesive effect of the lubricating oil can be improved to provide a smooth sliding operation of the external tube 10 and the shaft tube 20 and retard the wearing out of related components. Of course, each first pad can further comprise a plurality of recessions disposed at a section corresponding to the second rotation limit portion, and a plurality of protrusions disposed at a section corresponding to the first rotation limit portion to achieve the same effect.

Compared with the conventional structure, the steering limit device of a shock absorbent fork in accordance with the present invention can reduce the contact gap between the external tube and the shaft tube by the first pad to obtain a more stable and reliable steering effect and reduce the steering noise. If necessary, a worn-out first pad can be replaced with a new one to extend the service life of the steering limit device effectively.

What is claimed is:

1. A steering limit device of a shock absorbent fork, comprising:
an external tube, coupled to a handlebar of a bicycle, and having a plurality of first rotation limit portions disposed on an inner wall of a predetermined section of the external tube, and the external tube provided for a sliding section of the shaft tube having an external diameter greater than the external diameter of an upper section of the shaft tube;
a shaft tube, passed into the external tube and provided for connecting the fork of the bicycle, and having a plurality of second rotation limit portions disposed on an external wall of the shaft tube and extended into a section of the external tube and corresponding to the first rotation limit portions respectively;
a plurality of first pads, installed between the corresponding first rotation limit portions and second rotation limit portions, and each first pad being displaced axially with respect to the external tube and the shaft tube, and each first pad in conjunction with the first rotation limit portion and the second rotation limit restricting a relative rotation of the external tube and the shaft tube to achieve the effect of steering the fork by controlling the handlebar of the bicycle.

2. The steering limit device of a shock absorbent fork according to claim 1, wherein the shaft tube has a plurality of second pads disposed at an upper section of the second rotation limit portion and slidably contacted with an inner wall of the external tube.

3. The steering limit device of a shock absorbent fork according to claim 1, wherein each second rotation limit portion of the shaft tube is in a concave arc shape, and each first pad has a plurality of protrusions disposed at a section corresponding to the second rotation limit portion.

4. The steering limit device of a shock absorbent fork according to claim 3, wherein each first pad has a plurality of recessions disposed at a section corresponding to the first rotation limit portion.

5. The steering limit device of a shock absorbent fork according to claim 1, wherein each second rotation limit portion of the shaft tube is in a concave arc shape, and each first pad has a plurality of recessions disposed at a section corresponding to the second rotation limit portion.

6. The steering limit device of a shock absorbent fork according to claim 5, wherein each first pad has a plurality of protrusions disposed at a section corresponding to the first rotation limit portion.

7. The steering limit device of a shock absorbent fork according to claim 1, wherein the external tube has an elastic dustproof cover coupled to the fork of the bicycle.

8. The steering limit device of a shock absorbent fork according to claim 1, wherein the shaft tube at a section of the second rotation limit portion section has an external diameter greater than the external diameter of an upper section of the shaft tube.

9. The steering limit device of a shock absorbent fork according to claim 1, wherein the steering limit device further comprises a guide column disposed in the shaft tube for limiting a relative sliding stroke of the shaft tube and the external tube, and an elastic element installed between the guide column and the shaft tube for elastically restoring the external tube and the shaft tube to their original positions.

10. The steering limit device of a shock absorbent fork according to claim 9, wherein the external tube comprises a fixed block disposed on an inner wall of the top of the shaft tube and having a screw hole formed at the center of the fixed block, and the tip of the guide column being passed through the shaft tube and screwed into the screw hole; a disc cover installed at the bottom of the shaft tube for restricting the elastic element from falling off, and having a through hole formed at the center of the disc cover; a support ring installed at a position proximate to the bottom of the guide column, and the guide column at a position wherein the guide column passes through the through hole of the support ring having an external diameter greater than a stop portion of the support ring through hole, and the stop portion being disposed at the top of the elastic element and coupled and abutted with the elastic element.

11. The steering limit device of a shock absorbent fork according to claim 9, wherein the shaft tube has a plurality of second pads installed at an upper section corresponding to the second rotation limit portion and slidably contacted with an inner wall of the external tube.

12. The steering limit device of a shock absorbent fork according to claim 9, wherein each second rotation limit portion of the shaft tube is in a concave arc shape, and each first pad has a plurality of protrusions disposed at a section corresponding to the second rotation limit portion.

13. The steering limit device of a shock absorbent fork according to claim 12, wherein each first pad has a plurality of recessions disposed at a section corresponding to the first rotation limit portion.

14. The steering limit device of a shock absorbent fork according to claim 9, wherein each second rotation limit portion of the shaft tube is in a concave arc shape, and each first pad has a plurality of recessions disposed at a section corresponding to the second rotation limit portion.

15. The steering limit device of a shock absorbent fork according to claim 14, wherein each first pad has a plurality of protrusions disposed at a section corresponding to the first rotation limit portion.

16. The steering limit device of a shock absorbent fork according to claim 9, wherein the external tube has an elastic dustproof cover installed at the bottom of the external tube and coupled to the fork of the bicycle fork.

17. The steering limit device of a shock absorbent fork according to claim 9, wherein the shaft tube at a section of the second rotation limit portion has an external diameter greater than the external diameter of an upper section of the shaft tube.
